(19) United States
(12) Patent Application Publication
(10) Pub. No.: US 2026/0012345 A1
(43) Pub. Date: Jan. 8, 2026

(54) TRUST COOKIE

(71) Applicant: Wells Fargo Bank, N.A., San Francisco, CA (US)

(72) Inventors: Nicholas Richard Gillis, Martinsburg, WV (US); Michael J. Quinlan, San Francisco, CA (US)

(21) Appl. No.: 18/764,035

(22) Filed: Jul. 3, 2024

(51) Int. Cl. H04L 9/32

(52) U.S. Cl. CPC H04L 9/32

(57) ABSTRACT

A system may receive a first cryptographic security credential stored on a user device, alter the first cryptographic security credential using a deterministic cryptographic function, and compare the altered first cryptographic security credential to a second cryptographic security credential stored in a block in a first data structure. A system may in response to a determination that the altered first cryptographic security credential matches the second cryptographic security credential: cause the altered first cryptographic security credential to be stored on the user device, generate a third cryptographic security credential by applying the deterministic cryptographic function to the second cryptographic security credential, store the third cryptographic security credential on a new block of the first data structure, and grant access to the resource based at least in part on the determination that the altered first cryptographic security credential matches the second cryptographic security credential.

### BACKGROUND

Enterprises provide access to gated content, resources, and services through channels. Enterprises receive requests to access content, resource, or service from both legitimate users and attackers. A legitimate user can gain access to gated content, resource, or service in response to an enterprise authorizing the user, for example, a user login, and such legitimate users can continue to access the gated content, resource, or service with subsequent interactions during the same session. Attackers, such as fraudulent users, hackers, and bots, may attempt to illegitimately access gated content, resource, or service by launching an attack. For example, a fraudulent attack by using stolen credentials, or may try to guess details of legitimate credentials to gain access.

Enterprises try to balance deterring attackers and enabling legitimate users to access content, resources, and/or services without excessive inconvenience.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, according to some examples.

FIG. 2 is a block diagram illustrating further details regarding the enterprise system 100, according to some examples.

FIG. 3 is a diagrammatic representation of the cryptography system, according to some examples.

FIG. 4 is a block diagram depicting an embodiment of a single blockchain included in a digital distributed ledger accessed and edited by the cryptographic security credential generator of FIG. 3.

FIG. 5 is a flow diagram illustrating a method for using cryptographic security credentials to maintain security in an online service, in accordance with an example embodiment.

FIG. 6 is a flow diagram illustrating a method for using cryptographic security credential information stored in one or more blockchains to detect malicious access attempts to a service, in accordance with an example embodiment.

Generating a model may include multiple phases that form part of a machine-learning pipeline, including for example the following phases illustrated in FIG. 7.

FIG. 8 illustrates further details of two example phases, namely a training phase and a deployment phase, in accordance with an example embodiment.

FIG. 9 illustrates generally an example of a block diagram of a machine upon which any one or more of the techniques (e.g., methodologies) discussed herein may perform in accordance with some embodiments.

### DETAILED DESCRIPTION

The systems, methods, and techniques described herein may be used to deter fraudulent attacks on an enterprise by providing a security credential, such as a cryptographic token, to a user. This security credential may then be altered in some defined way based on a formula as the user accesses the enterprise (either upon login, or during each interaction, or both). Upon attempting to subsequently access the enterprise, the security credential may be checked against what the credential is expected to be based on the formula. If the security credential matches the expectation, then this is indicative that the user is more likely to be a legitimate user than if the security credential did not match the expectation. Additionally, the security credentials used may be stored in a blockchain, with each combination of underlying details about the user (e.g., each combination of user and device) having its own chain in the blockchain. This allows information about past attempts to be used to evaluate whether security credentials are from the users that they appear to be from, as well as to evaluate access attempts across the entire enterprise, which helps prevent large-scale attacks even in scenarios where individual attacks may not be detected or flagged.

It should be noted that the term “resource” as used throughout this disclosure shall be interpreted broadly to mean anything a user or device is trying to access, including, but not limited to, content, services, virtual locations, etc.

Cryptographic tokens have been used to protect actions like logons to websites or applications, but theft of such tokens have become more common in recent years, especially as attackers continue to innovate new forms of attacks on enterprises. By using a formula-based alteration of a cryptographic token and altering such tokens on a more frequent basis, such as modifying them each time an interaction is made as opposed to only for logon events, the theft of such tokens becomes less of a threat. In fact, in some instances, the theft of such tokens can be viewed as a positive, as the system as a whole is able to be alerted to the fact that a token may have been compromised without granting access to the malicious entity using the stolen token.

Additionally, by using the aforementioned blockchain technology, it becomes possible to track cryptographic token usage across many different interactions with a user, as well as among other users in the system, allowing for more robust detection of enterprise-level threats. While individual token theft is of course always a potential issue, more commonly attackers are able to get access to a large number of stolen tokens at once and then attempt a system-wide data breach using a high volume of stolen tokens in a short period of time. The tracking information stored in the blockchain allows the system to detect such system-wide attacks much more effectively than in the past.

It should be noted that while embodiments utilizing blockchain technology are described extensively in the present disclosure, it should be noted that implementations are possible where other data structures are used instead of blockchains. Any data structure with nodes or blocks that are used to compute further nodes or blocks in the same data structure could be used. Examples include directed graphs and trusted graphs.

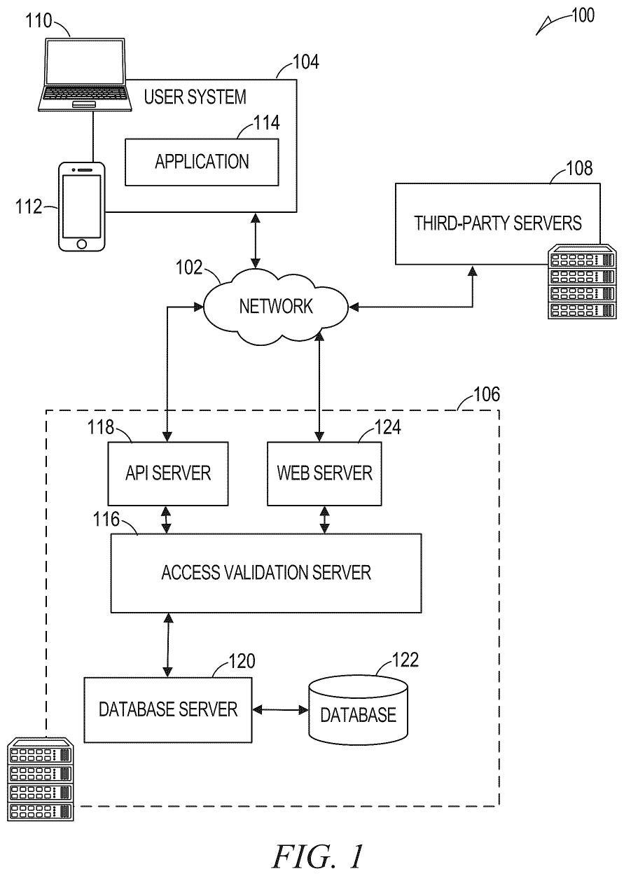

FIG. 1 is a diagrammatic representation of a networked environment in which the present disclosure may be deployed, according to some examples. FIG. 1 includes a block diagram showing an example enterprise system 100 for communicating over a network 102 (e.g., the Internet). The enterprise system 100 includes one or more user systems 104. According to some examples, each user system 104 is communicatively coupled, via one or more communication networks including the network 102, to an enterprise server system 106 and, optionally, third-party servers 108.

The user system 104 may be associated with a legitimate user or an attacker. The user system 104 can include one or more user devices, such as a computer device 110 or a mobile device 112, that are communicatively connected to exchange data (e.g., via the network 102). According to some examples, the computer device 110 is an automated teller machine (ATM). The user system 104 may be configured for voice calls (e.g., cell phone, voice over internet protocols, etc.).

The user system 104 can host at least one application 114. The application 114 can be a local instance of a client application of an enterprise or a web browser. The application 114 can communicate with other locally hosted applications 114 using APIs and can communicate with the network 102 via the user system 104.

The user system 104 interacts with the enterprise server system 106 via the network 102. The data exchanged between the user systems 104 and between the user systems 104 and the enterprise server system 106 can include functions (e.g., commands to invoke functions) and payload data (e.g., files, text, audio, video, or other data).

The enterprise server system 106 provides server-side functionality via the network 102 to the user systems 104. While certain functions of the enterprise system 100 are described herein as being performed by either the enterprise server system 106 or subsystems thereof, the location of certain functionality either within the enterprise server system 106 or the application 114 of the user system 104 may be a design choice. For example, it may be technically preferable to initially deploy particular technology and functionality within the enterprise server system 106 but to later migrate this technology and functionality to the application 114 where a user system 104 has sufficient processing capacity. Additionally, or alternatively, the enterprise server system 106 is able to provide, store, and modify device-side data (e.g., browser cookies, web storage such as local or session storage).

The enterprise server system 106 supports various services and operations that are provided to the user system 104. Such operations include receiving requests from, transmitting data to, receiving data from, and processing data from the user system 104. This data may include payload data, device information, geolocation information, passwords and user information, among other information. Data exchanges within the enterprise system 100 are invoked and controlled through functions available via user interfaces (UIs) of the user system 104.

Turning now specifically to the enterprise server system 106, an Application Program Interface (API) server 118 is connected to and provides programmatic interfaces to access validation server 116 making the functions of the access validation server 116 accessible to an application 114 of a user system 104, and third-party servers 108. The access validation server 116 is communicatively coupled to a database server 120, facilitating access to a database 122 that stores data associated with cryptographic security credentials such as tokens associated with the access validation server 116. Similarly, a web server 124 is coupled to the access validation server 116 and provides web-based interfaces to the access validation server 116. To this end, the web server 124 processes incoming network requests over the Hypertext Transfer Protocol (HTTP) and several other related protocols.

The API server 118 receives and transmits data (e.g., tokens and responses) among the access validation server 116 and the user system 104 (e.g., the application 114) and the third-party servers 108. Specifically, the API server 118 provides a set of interfaces (e.g., routines and protocols) that can be called or queried by the user system 104 (including e.g., the application 114) to invoke functionality of the access validation server 116. The API server 118 exposes various functions supported by the access validation server 116, including account registration; login functionality; transmitting data to the user system 104 (e.g., tokens); transmitting data from the user system 104 to the access validation server 116 (e.g., tokens); and other data interactions.

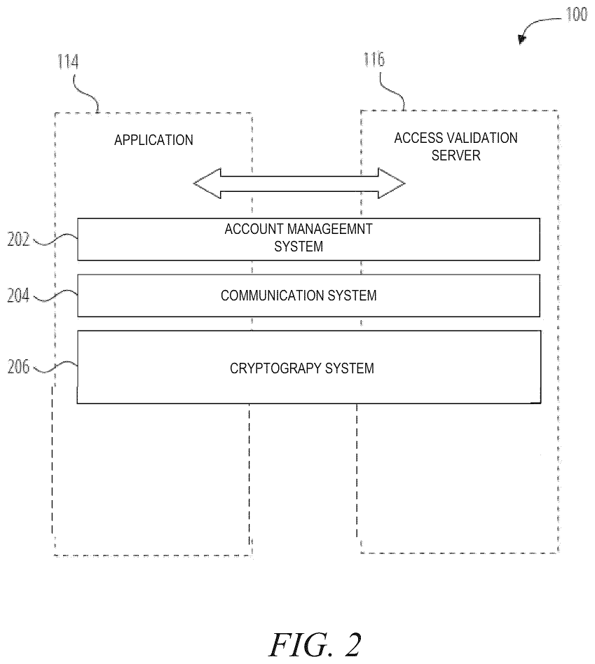

The access validation server 116 can host multiple systems and subsystems, described below with reference to FIG. 2.

FIG. 2 is a block diagram illustrating further details regarding the enterprise system 100, according to some examples. Specifically, the enterprise system 100 is shown to comprise the application 114 and the access validation server 116. The enterprise system 100 can embody multiple subsystems, which are supported on the device-side by the application 114 and on the server-side by the access validation server 116. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with other microservice components through well-defined APIs or interfaces, using lightweight protocols such as REST or messaging. The API interface defines the inputs and outputs of the microservice subsystem and how it interacts with other microservice subsystems of the enterprise system 100.
Data storage: A microservice subsystem may be responsible for its own data storage, which may be in the form of a database, cache, or other storage mechanism (e.g., using the database server 120 and database 122). This enables a microservice subsystem to operate independently of other microservices of the enterprise system 100.
Service discovery: Microservice subsystems may find and communicate with other microservice subsystems of the enterprise system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.
Reading and writing: Certain microservice subsystems may be enabled to read and write files. Microservices may leverage templating libraries to write to files served to a user device. Reading and writing mechanisms enable faster execution of issuance of challenges by reducing server and database queries.

In some examples, the enterprise system 100 may employ a monolithic architecture, a service-oriented architecture (SOA), a software-as-a-service (SaaS) architecture, a function-as-a-service (FaaS) architecture, or a modular architecture.

An account management system 202 is operationally responsible for the management of user accounts and associated data, and maintains entity information (e.g., stored in entity tables) regarding user accounts of users of the enterprise system 100. The account management system 202 can manage account authentication services between the application 114 and the access validation server 116. For example, in response to a valid authentication request, the access validation server 116 provides a cryptographic security credential (e.g., browser cookie, JSON web token (JWT)) for use by the application 114. This cryptographic security credential may be stored in a storage 203 of the application 114.

The account management system 202 may enable additional services associated with a user account, such as banking services (e.g., deposits, withdrawals, and other transactions), including automated banking services (e.g., automated teller machine transactions), and account management services (e.g., open an account, close an account, view statements). The account management system 202 may collect and maintain access data associated with requests for accessing content, resource, or services.

The communication system 204 enables and supports communication between a user system 104 and the enterprise server system 106. For example, the communication system 204 can enable and support messaging and audio communications (e.g., real-time messaging or audio calling) between a user system 104 and the enterprise system 100. For example, a user can access customer support through the communication system 204.

The cryptography system 206 may be responsible for generating and checking the cryptographic security credentials.

It should be noted that while FIG. 2 depicts a cryptography system 206 residing in a single location, this is merely one embodiment. A split architecture is possible where a portion of the cryptography system 206 resides on a server-side and another portion resides on a client-side. Indeed, further embodiments are possible where there are multiple client-side portions embodied as microservice front-ends. In some instances it may be necessary for these microservice front-ends to coordinate with each other (such as by sharing a logical clock).

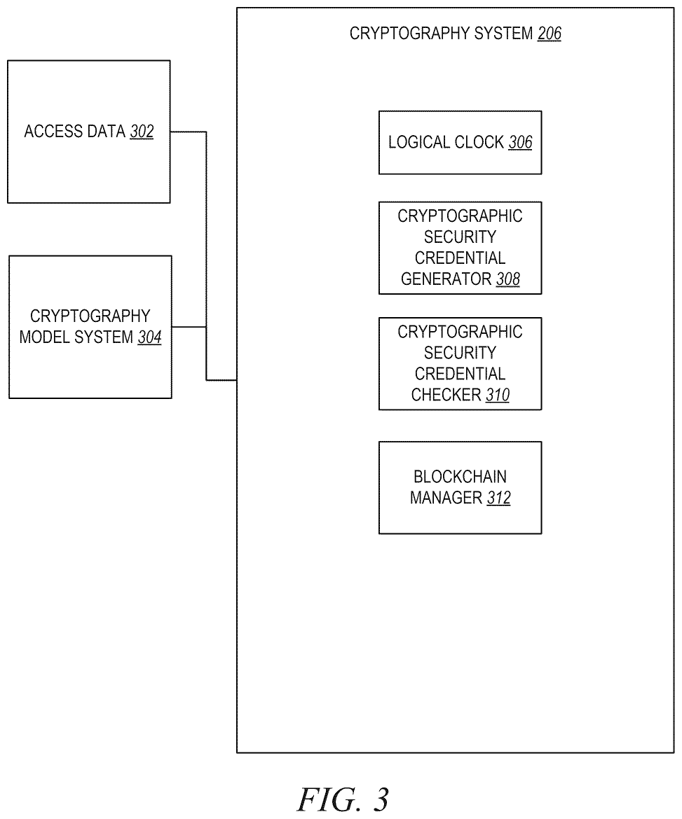

FIG. 3 is a diagrammatic representation of the cryptography system 206, according to some examples. The cryptography system 206 can include or otherwise have access to (e.g., via the network 102) access data 302 and the cryptography model system 304. The cryptography model system 304 is shown to comprise several additional subsystems including a logical clock 306, cryptographic security credential generator 308, cryptographic security credential checker 310, and blockchain manager 312. According to some examples, the cryptography system 206 can include additional or fewer subsystems, and functionality can be distributed differently among the subsystems.

The logical clock 306 can change a logical clock count each time the cryptographic security credential generator 308 generates a security credential for a user. In some example embodiments, this may involve incrementing the logical clock count by one each time the cryptographic security credential generator 308 generates a security credential for a user, but such an incrementation-by-one scheme is not the only possible implementation. Any deterministic function used to change the logical clock count may be used.

In an example embodiment, the cryptographic security credential generator 308 generates a cryptographic token as follows. H is a hash function. It may be performed on one or more pieces of information about or related to the user. Examples include user identification and device identification, but other types of information may be used in lieu of or in conjunction with this information. There are some advantages to hashing on both user identification and device identification. Specifically, a single user may be using two separate devices, and multiple users may be using a single device. As such, hashing on either user identification or device identification alone may lead to an inability to distinguish whether a request is coming from a different user or a different device than before. For simplicity, the hash function on user information will be denoted as H(U), but in reality U can be more than one piece of user-related information, as described above.

C represents a cookie that can be formed using the hash function. As such C=H(U). B is a generated block created from hashing a previous (or initial) block with the user information U. Thus, Bₙ=H(H(U), Bn−1).

The block may then be added to the blockchain by the blockchain manager 312. Specifically, each unique combination of user details (e.g., user identification and device identification) will have its own chain. Therefore, for example, user A on device 1 will have a different chain than user A on device 2. Likewise, user A on device 1 will have a different chain than user B on device 1.

A blockchain is a distributed ledger that is distributed among a number of different devices. Specifically, data on one device can be added to a blockchain and then data on a different device can be further added to the same blockchain, which is distributed among many devices.

In an example embodiment, the blockchains utilized are private blockchains, in which a single entity, such as a bank or other company controls all of the servers accessing and processing the blockchain. This allow the entity to have multiple divisions, servers, or other portions each access the same information without the need for traditional synchronization techniques.

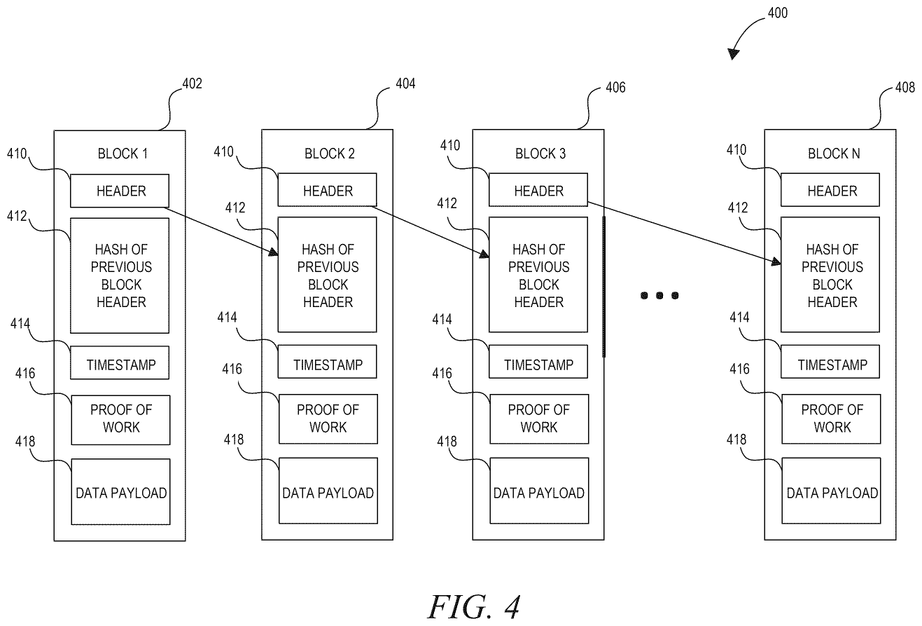

FIG. 4 is a block diagram depicting an embodiment of a single blockchain 400 included in a digital distributed ledger accessed and edited by the cryptographic security credential generator 308 of FIG. 3. In the depicted example, the blockchain 400 is illustrated as having multiple blocks 402, 404, 406, 408. The block 402 (first block in the blockchain 400) may have been created, for example, and allocated as a special starting block. The block 402 may include a unique header 410 uniquely identifying the block 402 from other blocks in the blockchain 400. Because the block 402 is the first block in the blockchain 400, a hash of previous block header 412 may be set to zero. A timestamp 414 may include the date of creation for the block 402, and a proof of work section 416 may include certain “work” that proves that a node (e.g., miner) has performed computations suitable for the creation of the block 402 and/or to verify transactions in the blockchain 400. The proof of work section 416 may vary based on a protocol used to create the blockchain 400. |One example protocol is a Merkle tree. The Merkle tree may be a tree data structure in which every leaf node is labelled with a hash (e.g., one-way hash) of a data block and every non-leaf node is labelled with a cryptographic hash of the labels of its child nodes. Because of the one-way transformation used in hashing, the Merkle tree has the property that there is no known technique that a deceptive party may use to guess a value that would hash with a second-to-last value to create the Merkle root, which is known from the verified blockchain 400, and so on, down the tree. In other words, this would prevent the creation of a fake value that would hash to our expected Merkle tree value (e.g., value stored in proof of work section 416 of the block 402), thus creating a single value that proves the integrity of all of the transactions under it.

Data, such as cryptographic security credentials that have been used by users may be stored in a data payload section 418 (and/or in another section). In certain embodiments, a new block may be created when a new data transmission record and/or data receipt record is to be created. For example, transmitting a certain file may result in the creation of a new block in the blockchain, which may be tied in via block ID to existing block(s). In another embodiment, empty blocks may be first created and then assigned to new blocks as new information. When a new block is created, the block will receive a new header 410 uniquely identifying the new block. A peer-to-peer network may include multiple nodes (e.g., computing devices used by various entities) that add blocks to the blockchain 400 based on the blockchain protocol. In general, the multiple nodes validate transactions or data that are to be added to a block, and compete (e.g., perform computing work, as introduced above) to have their respective block added to the blockchain 400. Validation of transactions and/or data includes verifying digital signatures associated with respective transactions and/or data. For a block to be added to the blockchain 400, a node must demonstrate a proof of work before their proposed block of transactions is accepted by the peer-to-peer network, and before the block is added to the blockchain 400. In certain embodiments, a blockchain protocol includes a proof of work scheme (e.g., Merkle Tree) that is based on a cryptographic hash function (CHF). An example CHF includes SHA256. In general, the CHF receives information as input, and provides a hash value as output, the hash value being of a predetermined length. For example, SHA256 outputs a 456-bit (32-byte, 64-character) hash value. In some examples, the hash value is a one-way hash value such that the output hash value cannot be ‘un-hashed’ to determine what the input was. The blockchain protocol can require multiple pieces of information as input to the CHF. For example, the input to the CHF can include a reference to the previous (most recent) block (e.g., hash 412) in the blockchain 400, details of the transaction(s) or data that are to be included in the to-be-created block, and a “nonce” value (e.g., a random number used only once).

The multiple nodes may compete to hash a set of data and to provide the next block that is to be added to the blockchain 400. The blockchain protocol provides a threshold hash to qualify a block to be added to the blockchain 400. For example, the threshold hash can include a predefined number of zeros (0's) that the hash value must have at the beginning (e.g., at least the first four characters of the hash value must each be zero). The higher the number of zeros, the more computationally time-consuming it may be to arrive at a qualifying hash value.

In accordance with the blockchain protocol, each node in the node's peer-to-peer network receives transaction information for one or more transactions that are to be included in a block that is to be added next in the blockchain 400. Each node provides the reference to the previous (most recent) block in the blockchain 400, details of the data or transaction(s) that are to be included in the to-be-created block (e.g., data receipt record and/or data transmission record), and the nonce value to the CHF that may then be used to provide a hash value. If the hash value does not meet the threshold hash (e.g., the first four characters of the hash value are not each zero), the node starts again to provide another hash value, thus increasing the amount of work. If the hash value meets the threshold hash (e.g., at least the first four characters of the hash value are each zero), the respective node may have successfully created the next block that is to be added to the blockchain 400. Consequently, the respective node's block is broadcast across the peer-to-peer network (e.g., all devices communicatively coupled to the digital distributed ledger-based system). All other nodes cease work (because one node was already successful), and all copies of the blockchain 400 are updated across the peer-to-peer network to append the block to the blockchain 400. Each node may produce hundreds of thousands (or more) of hash values, before any one node provides a qualifying hash value (e.g., at least the first four characters of the hash value are each zero).

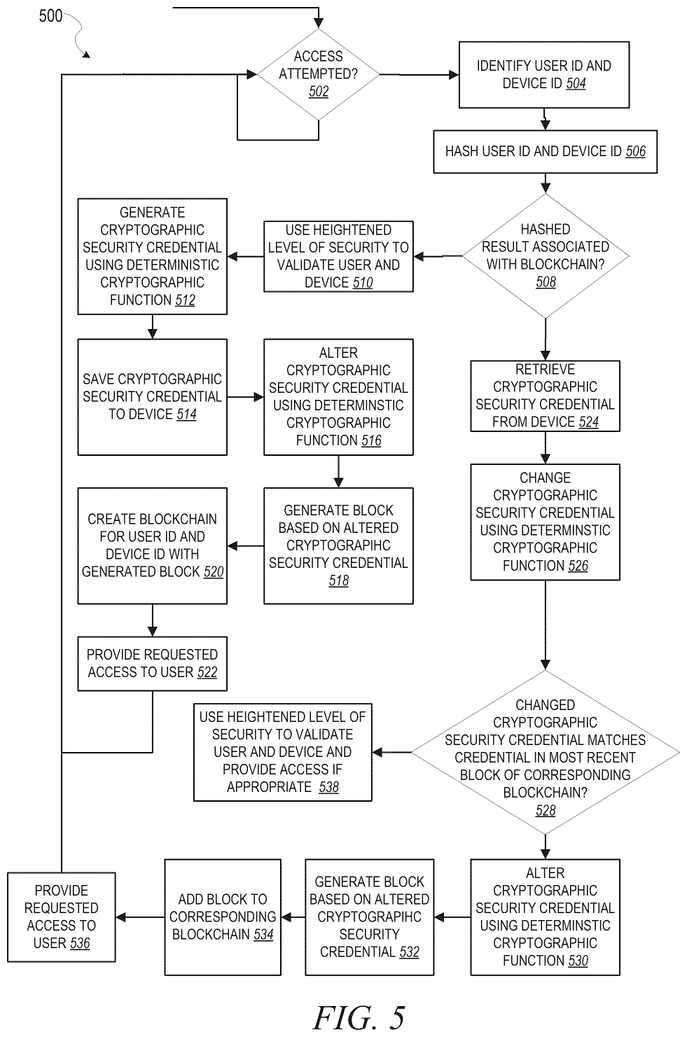

FIG. 5 is a flow diagram illustrating a method 500 for using cryptographic security credentials to maintain security in an online service, in accordance with an example embodiment. At operation 502, it is determined if an access to a resource is attempted. This access may be, for example, a logon request but also can include other types of accesses attempted by user devices after the logon request has been granted (e.g., during a session). At operation 504, a user identification and a device identification corresponding to the attempted access are identified. In some example embodiments, this information may be included in an access request. It should be noted that this user identification and device identification may be collectively referred to as “user information.” It is not necessary that both the user identification and the device identification be used in this or subsequent steps. In some example embodiment only one or the other is used. Additionally, other user/device information may be also included in this “user information” and collectively hashed and assigned to a single blockchain uniquely identifying to that combination of user information.

At operation 506, the user identification and device identification are hashed in accordance with a first hashing function. At operation 508, it is determined if the hashed user identification and device information are associated with a blockchain in a distributed ledger. If the user and device combination have been registered before, then there would be a blockchain corresponding to that combination in the distributed ledger, and a cookie would have been left behind on the device associated with the device identification. If not, then this may be the first time that the user has been attempting to access the resource from this device (or alternatively, their cookies may have been cleared). In such a case, it is desirable to use some sort of heightened level of security to validate the user and device, such as by using a two-factor authentication protocol in addition to a user name and password. Thus, if at operation 508 it is determined that the hashed user identification and device information are not associated with a blockchain, then at operation 510 a heighted level of security is used to validate the user and device. Then at operation 512 (assuming the user and device have been validated), a cryptographic security credential is generated for the user identification and device information combination using a deterministic cryptographic function. At operation 514, the cryptographic security credential is saved to the device associated with the device identification (e.g., as a cookie). At operation 516, the cryptographic security credential is altered based on the deterministic cryptographic function. Specifically, the deterministic cryptographic function describes not only what protocol to use to generate a cryptographic security credential, but also describes an alteration to be made to a prior cryptographic security credential based on a logical clock. Thus, the altered cryptographic security credential for the user identification and device identification is different than the formerly generated cryptographic security credential in some deterministic way (e.g., a value in the function incremented by one).

At operation 518, a block is generated based on the altered cryptographic security credential. At operation 520, a blockchain for the user identification and device information combination is created with the generated block from operation 518. At operation 522, the access the user has requested is provided.

If at operation 508 it is determined that the hashed user identification and device information are associated with a blockchain in the distributed ledger, then at operation 524 a cryptographic security credential is retrieved from the device associated with the device identification (such as by accessing a cookie storage on the device). At operation 526, the cryptographic security credential retrieved from the device is changed based on the deterministic cryptographic function. Similar to operation 518, this may include a change to be made based on a logical clock, such as incrementing a function value by one. At operation 528, the changed cryptographic security credential is compared with a cryptographic security credential in a most recent block of the blockchain corresponding to the user identification and device identification combination. If they match, then at operation 530 a new cryptographic security credential is generated for the user identification and device identification combination using the deterministic cryptographic function.

At operation 528, the new cryptographic security credential is saved to the device associated with the device identification (e.g., as a cookie). At operation 530, the new cryptographic security credential is altered based on the deterministic cryptographic function. At operation 532, a block is generated based on the altered new cryptographic security credential. At operation 534, the block is added to the blockchain for the user identification and device information. At operation 536, the access the user has requested is provided.

If at operation 528 it was determined that there was no match, then at operation 538, a heightened level of security may be used to validate the user and device and access is provided if appropriate.

The method 500 continues to repeat back to operation 502 to detect new accesses. Thus, the method 500 is continuously checking and generating new versions of the cryptographic security credential as well as saving this information to the blockchain. The blockchain therefore winds up containing a chain of information about previous attempts to access the resource, which as will be seen can be used to increase security measures based on prior attempts by the user to access the resource as well as based on attempts by other users to access the resource.

While there is no requirement that every access cause a change to the cryptographic security credential, it can be beneficial to cause the change fairly frequently, and particularly more often than merely causing such a change each time a user logs in to the resource. By changing the cryptographic security credential frequently, this significantly diminishes the possibility that a stolen cryptographic security credential may be used to successfully spoof a user and gain malicious access to the resource. Additionally, since the likelihood that such a theft would be successful drops so low, it actually becomes beneficial to have this particular type of cryptographic security credential stolen, since it allows for tracking of historical usage of the cryptographic security credential and such tracking of multiple cryptographic security credential across many users allows a system (such as a system running the resource) to detect malicious access patterns across multiple users when such patterns might not have otherwise raised suspicion if analyzed independently.

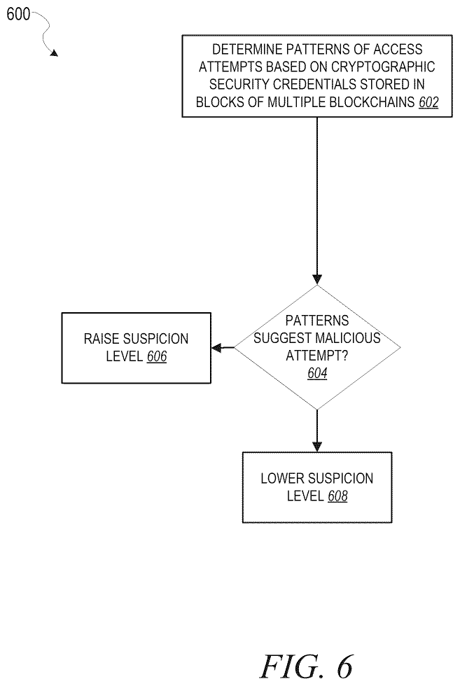

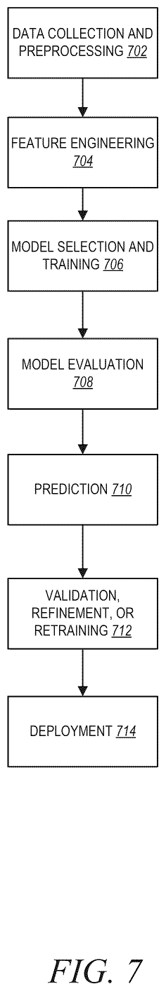

FIG. 6 is a flow diagram illustrating a method 600 for using cryptographic security credential information stored in one or more blockchains to detect malicious access attempts to a resource, in accordance with an example embodiment. It should be noted that this method 600 may be utilized in a number of different ways. It may be used, for example, to raise a malicious access attempt suspicion level for a particular individual user, such as by executing the method 600 prior to actually allowing access to the resource, such as between operation 520 and 522 of FIG. 5 and/or between operation 534 and operation 526 of FIG. 5. In such an embodiment, even though the user and device may have been deemed “valid” by an enhanced security protocol or by the cryptographic security credential stored in the cookie being successfully used to match a cryptographic security credential stored in the blockchain, a pattern of access, either by this particular user or by a group of users, may still be used to deny access to the resource for this particular user.

It should be noted that granting or denying access to a resource need not be a binary decision. Information such as the fact that the user's cryptographic security credential stored in the cookie is not being successfully used to match a cryptographic security credential stored in the blockchain, or detecting a higher likelihood of malicious access as a result of method 600 (FIG. 6), need not result in the user actually being denied access. Rather, the system can instead apply different security protocols to different levels of suspicion. For example, higher and higher levels of validation may be required for higher and higher levels of suspicion.

At operation 602, patterns of access attempts are determined based on cryptographic security credentials stored in blocks of multiple blockchains in a distributed ledger. At operation 604, it is determined whether these patterns are suggestive of a malicious attempt at access. If so, then at operation 606, a suspicion level is raised, causing increased security protocols to be used to validate one or more users' access attempts. If not, then at operation 608, a suspicion level is lowered, causing decreased security protocols to be used to validate one or more users' access attempts.

The patterns themselves may, in some example embodiments, be detected using machine learning (ML) model(s). The one or more ML model(s) can be trained using historical access data. Additionally, or alternatively, the one or more ML model(s) can collect data on suspected or known attackers after deployment to improve abilities to identify attackers. Further, the one or more ML model(s) may learn from ongoing requests for access to determine combinations in responses that work best at deterring attacks. The data gathered and ingested by the one or more ML model(s) does not include personally-identifiable information (PII) about users.

Machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

According to some examples, a predictive model is implemented using unsupervised learning where the predictive model learns over time to recognize patterns of fraudulent attackers, such as characteristics of user devices uses by attackers, specifically patterns of attempts at access using cryptographic security credentials as recorded in blockchains in the distributed ledger, but also potentially characteristics of IP addresses or attackers, patterns in events (e.g., click, tap, keystroke), and other patterns and characteristics the predictive model observes over time. Additionally, or alternatively, the predictive model can learn to recognize such characteristics and patterns of behavior observed in legitimate users.

Moreover, attackers are known to sometimes ‘case the joint’ by acting as a legitimate user to gather information about the enterprise and existing security measures. The predictive model may further recognize patterns of attackers acting as legitimate users, for example, by identifying patterns typically observed in attackers in a seemingly legitimate user. The predictive model continues to learn and improve as attackers develop new techniques and methodologies.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., a user device being classified as an attacker or legitimate user). Regression algorithms aim at quantifying some items (e.g., quantifying likelihood a user device is an attacker).

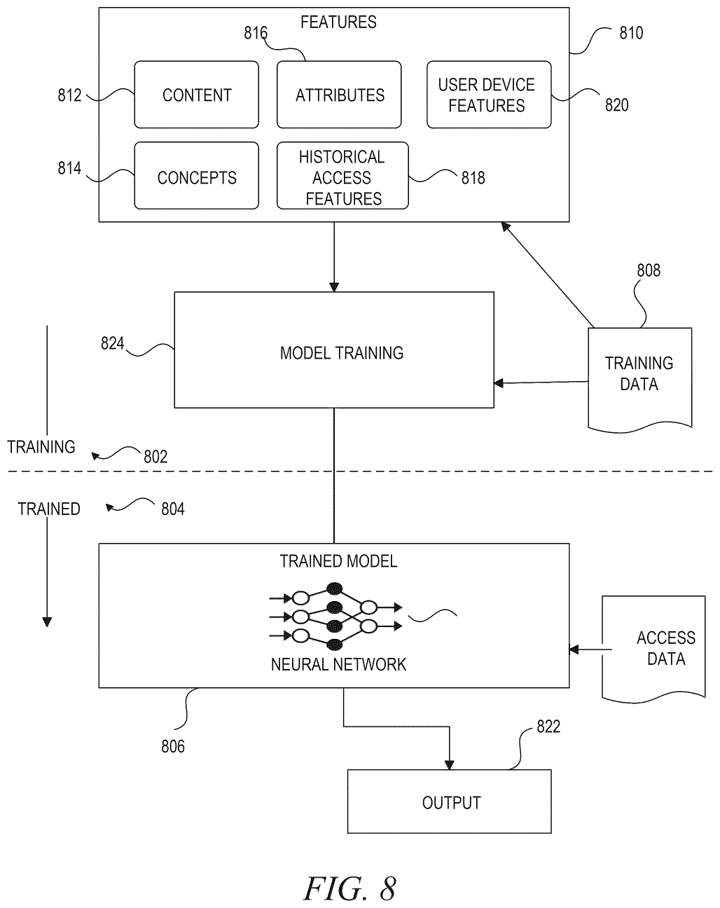

Generating a model may include multiple phases that form part of a machine-learning pipeline 700, including for example the following phases illustrated in FIG. 7:
Data collection and preprocessing 702: This phase may include acquiring and cleaning data (e.g., access data) to ensure that it is suitable for use in the machine learning model. This phase may also include removing duplicates, handling missing values, and converting data into a suitable format.
Feature engineering 704: This phase may include selecting and transforming the training data 808 (FIG. 8) to create features that are useful for predicting the target variable. Feature engineering may include (1) receiving features 810 (FIG. 8) (e.g., as structured or labeled data in supervised learning) and/or (2) identifying features 810 (e.g., unstructured or unlabeled data for unsupervised learning) in training data 808.
Model selection and training 706: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 708: This phase may include evaluating the performance of a trained model on a separate testing dataset. This phase can help determine if the model is overfitting or underfitting and determine whether the model is suitable for deployment.
Prediction 710: This phase involves using a trained model to generate predictions on new, unseen data.
Validation, refinement or retraining 712: This phase may include updating a model based on feedback generated from the prediction phase, such as new data or user feedback.
Deployment 714: This phase may include integrating the trained model into a more extensive system or application, such as a web service, mobile app, or IoT device. This phase can involve setting up APIs, building a user interface, and ensuring that the model is scalable and can handle large volumes of data.

FIG. 8 illustrates further details of two example phases, namely a training phase 802 (e.g., part of the model selection and trainings 706 and model evaluation 708) and a deployment phase 804 (e.g., part of the prediction 710, validation, refinement or retraining 712, and deployment 714). Prior to the training phase 802, feature engineering 704 is used to identify features 810. This may include identifying informative, discriminating, and independent features for effectively operating a trained model 806 in pattern recognition, classification, and regression. As used herein, trained model 806 may refer to the predictive model.

The training data 808 comprises a training version of access data, according to some examples. In some examples, the training data 808 includes labeled data, known for pre-identified features 810 and one or more outcomes. Each of the features 810 may be a variable or attribute, such as an individual measurable property of a process, article, system, or phenomenon represented by a data set (e.g., the training data 808). Features 810 may also be of different types, such as numeric features, strings, and graphs, and may include one or more of content 812, concepts 814, attributes 816, historical access features 818, and/or user device features 820, merely for example. The historical access features 818 can comprise features generated from historical access data in the training data 808. The user device features 820 can comprise features generated from user device information in the training data 808.

In training phase 802, the machine-learning pipeline 700 uses the training data 808 to find correlations among the features 810 that affect a predicted outcome or output 822. With the training data 808 and the identified features 810, the model is trained during the training phase 802 during model training 824. The model training 824 appraises values of the features 810 as they correlate to the training data 808. The result of the training is a trained or learned model 806.

Further, the training phase 802 may involve machine learning, in which the training data 808 is structured (e.g., labeled during preprocessing operations). The trained model 806 may implement a neural network capable of performing, for example, classification and clustering operations. In other examples, the training phase 802 may involve deep learning, in which the training data 808 is unstructured, and the trained model 806 may implement a deep neural network that can perform both feature extraction and classification/clustering operations.

In some examples, a neural network may be generated during the training phase 802 and implemented within the trained model 806. The neural network includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 802, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the trained model 806 may be tested on a new dataset. The testing dataset is used to evaluate the performance of the trained model 806 and ensure that the model has not overfitted the training data 808.

During deployment phase 804, the trained model 806 produce an output 822. Access data may be provided as an input to the trained model 806, and the trained model 806 generates the output 822 responsive to receipt of the access data. In the deployment phase 804, the trained model 806 may use the features 810 for analyzing access data to generate inferences, outcomes, or predictions, as examples of an output 822.

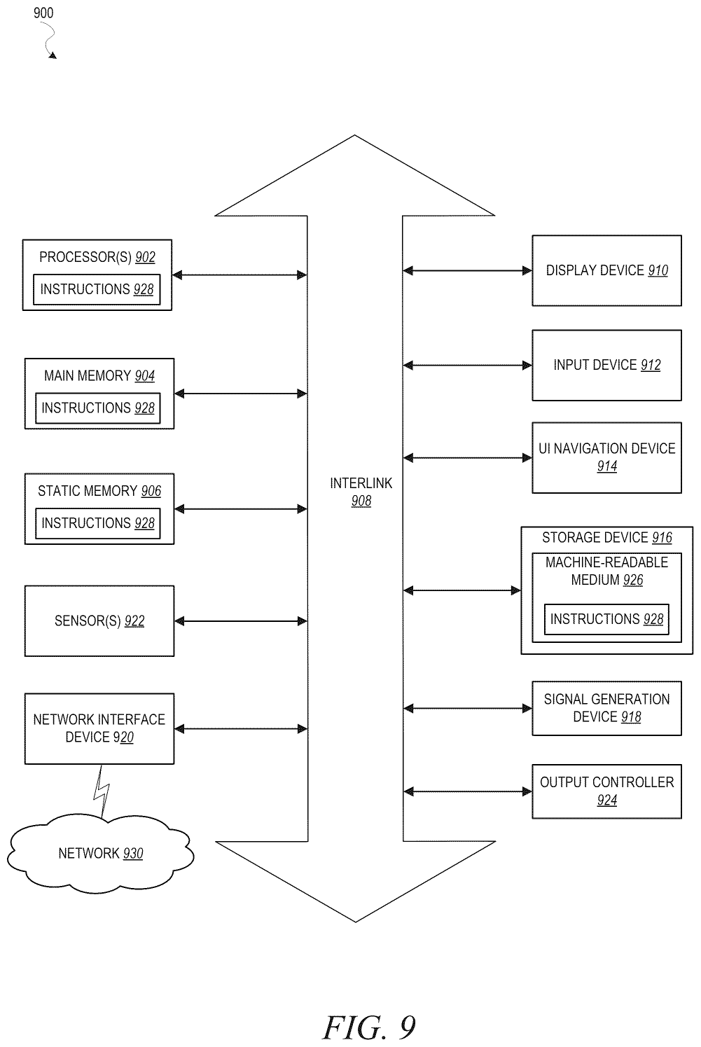

FIG. 9 illustrates generally an example of a block diagram of a machine 900 upon which any one or more of the techniques (e.g., methodologies) discussed herein may perform in accordance with some embodiments. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 900 may include a hardware processor(s) 902 (e.g., a CPU, a GPU, a hardware processor core, or any combination thereof), a main memory 904 and a static memory 906, some or all of which may communicate with each other via an interlink 908 (e.g., a bus). The machine 900 may further include a display device 910, an alphanumeric input device 912 (e.g., a keyboard), and a UI navigation device 914 (e.g., a mouse). In an example, the display device 910, alphanumeric input device 912 and UI navigation device 914 may be a touch screen display. The machine 900 may additionally include a storage device 916 (e.g., drive unit), a signal generation device 918 (e.g., a speaker), a network interface device 920, and one or more sensor(s) 922, such as a global positioning system (GPS) sensor, compass, accelerometer, or other sensor. The machine 900 may include an output controller 924, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable machine-readable medium 926 that is non-transitory on which is stored one or more sets of data structures or instructions 928 (e.g., software) embodying or utilized by any one or more of the techniques or functions described herein. The instructions 928 may also reside, completely or at least partially, within the main memory 904, within static memory 906, or within the hardware processor(s) 902 during execution thereof by the machine 900. In an example, one or any combination of the hardware processor(s) 902, the main memory 904, the static memory 906, or the storage device 916 may constitute machine readable media.

While the machine readable machine-readable medium 926 is illustrated as a single medium, the term “machine readable medium” may include a single medium or multiple media (e.g., a centralized or distributed database, or associated caches and servers) configured to store the one or more instructions 928.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory [EEPROM]) and flash memory devices; magnetic disks, such as internal hard disks and removable disks; magneto-optical disks; and CD-ROM and DVD-ROM disks.

The instructions 928 may further be transmitted or received over a communications network 930 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 902.11 family of standards known as Wi-Fi®, IEEE 902.16 family of standards known as WiMax®), IEEE 902.15.4 family of standards, peer-to-peer (P2P) networks, among others. In an example, the network interface device 920 may include one or more physical jacks (e.g., Ethernet, coaxial, or phone jacks) or one or more antennas to connect to the communications network 930. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The following, non-limiting examples, detail certain aspects of the present subject matter to solve the challenges and provide the benefits discussed herein, among others.

Example 1 is a method comprising: receiving, from a user device operated by a user, a request to access a resource; identifying information about the user; receiving a first cryptographic security credential stored on the user device; altering the first cryptographic security credential using a deterministic cryptographic function; comparing the altered first cryptographic security credential to a second cryptographic security credential stored in a block in a first data structure, the first data structure uniquely corresponding to the information about the user; in response to a determination that the altered first cryptographic security credential matches the second cryptographic security credential: causing the altered first cryptographic security credential to be stored on the user device; generating a third cryptographic security credential by applying the deterministic cryptographic function to the second cryptographic security credential; storing the third cryptographic security credential on a new block of the first data structure; and granting access to the resource based at least in part on the determination that the altered first cryptographic security credential matches the second cryptographic security credential.

In Example 2, the subject matter of Example 1 includes, wherein the first data structure is a blockchain and is identified by hashing the information about the user.

In Example 3, the subject matter of Example 2 includes, wherein the information about the user includes a user identification and a device identification.

In Example 4, the subject matter of Examples 2-3 includes, identifying one or more patterns of access to the resource by multiple users by analyzing multiple cryptographic security credentials stored in multiple blocks of multiple blockchains; and wherein the granting access to the resource is based partially on the identified one or more patterns.

In Example 5, the subject matter of Example 4 includes, wherein the identifying one or more patterns includes using a machine learning model to analyze the multiple cryptographic security credentials stored in multiple blocks of multiple blockchains of the distributed ledger to identify patterns of likely malicious behavior.

In Example 6, the subject matter of Examples 1-5 includes, in response to the determination that the altered first cryptographic security credential does not match the second cryptographic security credential: blocking access to the resource based until the user is validated using an enhanced security protocol.

In Example 7, the subject matter of Examples 1-6 includes, wherein the first cryptographic security credential is generated using a random number, in accordance with the deterministic cryptographic function.

In Example 8, the subject matter of Examples 1-7 includes, wherein the first cryptographic security credential is a cryptographic token.

In Example 9, the subject matter of Example 8 includes, wherein the cryptographic token is stored in the user device as a cookie.

Example 10 is a system comprising: processing circuitry; and memory, including instructions, which when executed by the processing circuitry, causes the processing circuitry to perform operations comprising: receiving, from a user device operated by a user, a request to access a resource; identifying information about the user; receiving a first cryptographic security credential stored on the user device; altering the first cryptographic security credential using a deterministic cryptographic function; comparing the altered first cryptographic security credential to a second cryptographic security credential stored in a block in a first data structure, the first data structure uniquely corresponding to the information about the user; in response to a determination that the altered first cryptographic security credential matches the second cryptographic security credential: causing the altered first cryptographic security credential to be stored on the user device; generating a third cryptographic security credential by applying the deterministic cryptographic function to the second cryptographic security credential; storing the third cryptographic security credential on a new block of the first data structure; and granting access to the resource based at least in part on the determination that the altered first cryptographic security credential matches the second cryptographic security credential.

In Example 11, the subject matter of Example 10 includes, wherein the first data structure is a blockchain and is identified by hashing the information about the user.

In Example 12, the subject matter of Example 11 includes, wherein the information about the user includes a user identification and a device identification.

In Example 13, the subject matter of Examples 11-12 includes, wherein the operations further comprise: identifying one or more patterns of access to the resource by multiple users by analyzing multiple cryptographic security credentials stored in multiple blocks of multiple blockchains; and wherein the granting access to the resource is based partially on the identified one or more patterns.

In Example 14, the subject matter of Example 13 includes, wherein the identifying one or more patterns includes using a machine learning model to analyze the multiple cryptographic security credentials stored in multiple blocks of multiple blockchains to identify patterns of likely malicious behavior.

In Example 15, the subject matter of Examples 10-14 includes, wherein the operations further comprise: in response to the determination that the altered first cryptographic security credential does not match the second cryptographic security credential: blocking access to the resource based until the user is validated using an enhanced security protocol.

In Example 16, the subject matter of Examples 10-15 includes, wherein the first cryptographic security credential is generated using a random number, in accordance with the deterministic cryptographic function.

In Example 17, the subject matter of Examples 10-16 includes, wherein the first cryptographic security credential is a cryptographic token.

In Example 18, the subject matter of Example 17 includes, wherein the cryptographic token is stored in the user device as a cookie.

Example 19 is a non-transitory computer-readable storage medium, the computer-readable storage medium including instructions that when executed by a computer, cause the computer to: receiving, from a user device operated by a user, a request to access a resource; identifying information about the user; receiving a first cryptographic security credential stored on the user device; altering the first cryptographic security credential using a deterministic cryptographic function; comparing the altered first cryptographic security credential to a second cryptographic security credential stored in a block in a first data structure, the first data structure uniquely corresponding to the information about the user; in response to a determination that the altered first cryptographic security credential matches the second cryptographic security credential: causing the altered first cryptographic security credential to be stored on the user device; generating a third cryptographic security credential by applying the deterministic cryptographic function to the second cryptographic security credential; storing the third cryptographic security credential on a new block of the first data structure; and granting access to the resource based at least in part on the determination that the altered first cryptographic security credential matches the second cryptographic security credential.

In Example 20, the subject matter of Example 19 includes, wherein the first data structure is a blockchain and is identified by hashing the information about the user device or user.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving, from a user device operated by a user, a request to access a resource;
identifying information about the user;
receiving a first cryptographic security credential stored on the user device;
altering the first cryptographic security credential using a deterministic cryptographic function;
comparing the altered first cryptographic security credential to a second cryptographic security credential stored in a block in a first data structure, the first data structure uniquely corresponding to the information about the user;
in response to a determination that the altered first cryptographic security credential matches the second cryptographic security credential:
causing the altered first cryptographic security credential to be stored on the user device;
generating a third cryptographic security credential by applying the deterministic cryptographic function to the second cryptographic security credential;
storing the third cryptographic security credential on a new block of the first data structure; and
granting access to the resource based at least in part on the determination that the altered first cryptographic security credential matches the second cryptographic security credential.

2. The method of claim 1, wherein the first data structure is a blockchain and is identified by hashing the information about the user.

3. The method of claim 2, wherein the information about the user includes a user identification and a device identification.

4. The method of claim 2, further comprising:
identifying one or more patterns of access to the resource by multiple users by analyzing multiple cryptographic security credentials stored in multiple blocks of multiple blockchains; and
wherein the granting access to the resource is based partially on the identified one or more patterns.

5. The method of claim 4, wherein the identifying one or more patterns includes using a machine learning model to analyze the multiple cryptographic security credentials stored in multiple blocks of multiple blockchains of the distributed ledger to identify patterns of likely malicious behavior.

6. The method of claim 1, further comprising:
in response to the determination that the altered first cryptographic security credential does not match the second cryptographic security credential:
blocking access to the resource based until the user is validated using an enhanced security protocol.

7. The method of claim 1, wherein the first cryptographic security credential is generated using a random number, in accordance with the deterministic cryptographic function.

8. The method of claim 1, wherein the first cryptographic security credential is a cryptographic token.

9. The method of claim 8, wherein the cryptographic token is stored in the user device as a cookie.

10. A system comprising:
processing circuitry; and
memory, including instructions, which when executed by the processing circuitry, causes the processing circuitry to perform operations comprising:
receiving, from a user device operated by a user, a request to access a resource;
identifying information about the user;
receiving a first cryptographic security credential stored on the user device;
altering the first cryptographic security credential using a deterministic cryptographic function;
comparing the altered first cryptographic security credential to a second cryptographic security credential stored in a block in a first data structure, the first data structure uniquely corresponding to the information about the user;
in response to a determination that the altered first cryptographic security credential matches the second cryptographic security credential:
causing the altered first cryptographic security credential to be stored on the user device;
generating a third cryptographic security credential by applying the deterministic cryptographic function to the second cryptographic security credential;
storing the third cryptographic security credential on a new block of the first data structure; and
granting access to the resource based at least in part on the determination that the altered first cryptographic security credential matches the second cryptographic security credential.

11. The system of claim 10, wherein the first data structure is a blockchain and is identified by hashing the information about the user.

12. The system of claim 11, wherein the information about the user includes a user identification and a device identification.

13. The system of claim 11, wherein the operations further comprise:
identifying one or more patterns of access to the resource by multiple users by analyzing multiple cryptographic security credentials stored in multiple blocks of multiple blockchains; and
wherein the granting access to the resource is based partially on the identified one or more patterns.

14. The system of claim 13, wherein the identifying one or more patterns includes using a machine learning model to analyze the multiple cryptographic security credentials stored in multiple blocks of multiple blockchains to identify patterns of likely malicious behavior.

15. The system of claim 10, wherein the operations further comprise:
in response to the determination that the altered first cryptographic security credential does not match the second cryptographic security credential:
blocking access to the resource based until the user is validated using an enhanced security protocol.

16. The system of claim 10, wherein the first cryptographic security credential is generated using a random number, in accordance with the deterministic cryptographic function.

17. The system of claim 10, wherein the first cryptographic security credential is a cryptographic token.

18. The system of claim 17, wherein the cryptographic token is stored in the user device as a cookie.

19. A non-transitory computer-readable storage medium, the computer-readable storage medium including instructions that when executed by a computer, cause the computer to:
receiving, from a user device operated by a user, a request to access a resource;
identifying information about the user;
receiving a first cryptographic security credential stored on the user device;
altering the first cryptographic security credential using a deterministic cryptographic function;
comparing the altered first cryptographic security credential to a second cryptographic security credential stored in a block in a first data structure, the first data structure uniquely corresponding to the information about the user;
in response to a determination that the altered first cryptographic security credential matches the second cryptographic security credential:
causing the altered first cryptographic security credential to be stored on the user device;
generating a third cryptographic security credential by applying the deterministic cryptographic function to the second cryptographic security credential;
storing the third cryptographic security credential on a new block of the first data structure; and
granting access to the resource based at least in part on the determination that the altered first cryptographic security credential matches the second cryptographic security credential.

20. The non-transitory computer-readable storage medium of claim 19, wherein the first data structure is a blockchain and is identified by hashing the information about the user device or user.
